(19) United States
(12) Patent Application Publication
(10) Pub. No.: US 2025/0163974 A1
(43) Pub. Date: May 22, 2025

(54) Overload Clutch for an Actuating Mechanism for Actuating a Loading, Tank or Service Flap and Actuating Mechanism with such an Overload Clutch and Actuating Mechanism Having such an Overload Coupling

(71) Applicant: Illinois Tool Works Inc., Glenview, IL (US)

(72) Inventor: Roland OCH, Rottendorf (DE)

(21) Appl. No.: 18/939,790

(22) Filed: Nov. 7, 2024

(30) Foreign Application Priority Data
Nov. 16, 2023 (DE) 10 2023 132 006.8

(51) Int. Cl. F16D 7/04; E05B 83/34; E05F 15/63

(52) U.S. Cl. CPC F16D 7/044; E05B 83/34; E05F 15/63; E05Y 2900/534; E05Y 2900/535

(57) ABSTRACT

The disclosure relates to an overload coupling (1) which has a coupling element (2) on the input side and an output-side coupling element (3) and is designed to transfer a torque from the coupling element (2) on the input side coupling element (2) to transmit a torque to the output-side coupling element (3), and to break the form-fit and/or force-fit connection between the input-side coupling element (2) and the output-side coupling element (3) in the event of an overload. The overload coupling (1) is designed as a slip coupling, in which the coupling element (2) on the drive side and the output-side coupling element (3) together form the coupling halves of a gear coupling. According to the disclosure, it is in particular envisaged that the drive-side coupling element (2) is provided with a first front toothing (5.1) on a side facing the output-side coupling element (3), and the output-side coupling element (3) is provided with a second front toothing (5.2) on a side facing the drive-side coupling element (2), the first front toothing (5.1) is designed to be complementary to the second front toothing (5.2) in such a way that the two front toothings (5.1, 5.2) can engage in one another only when the drive-side coupling element (2) has a unique and predetermined rotational position with respect to the output-side coupling element (3).

### RELATED APPLICATIONS

The present application claims the benefit of German Patent Application No. 10 2023 132 006.8, filed Nov. 16, 2023, titled “Overload Clutch for an Actuating Mechanism for Actuating a Loading, Tank or Service Flap and Actuating Mechanism with such an Overload Clutch,” the contents of which are hereby incorporated by reference.

### BACKGROUND

The vehicle is in particular a vehicle having a hybrid or electromotive drive, wherein however vehicles having a purely combustion-based drive are not excluded in the context of the present disclosure.

Vehicles with a hybrid or electromotive drive usually have one battery or traction battery, which, for example in the case of plug-in hybrid electric vehicle (PHEV) vehicles or battery electric vehicles (BEVs), can be charged via an electrical charging port that is accessible from the outside on the vehicle body, and is typically a charging port, by connecting to an electrical charging station, for example, or a conventional external electrical port.

The charging port is usually arranged in a charging compartment of the vehicle body, which is covered or closed by a charging flap or a charging closure element. A mechanism that cooperates with the charging flap or charging closure element selectively allows the charging compartment to be opened and closed or the charging flap or charging closure element to be flipped open and closed in relation to the charging compartment, and thus allows access to the charging port.

In vehicles with a combustion-based drive, a fuel tank is supplied with fuel via a tank filler-neck, which is accessible from the outside by connection to a fuel pump or a fuel nozzle, for example. Like the charging port, the filler neck is typically arranged in a filler neck housing that is associated with the vehicle body and is covered or closed by a fueling flap or a tank closure element. Here, too, a mechanism that cooperates with the fueling flap or tank closure element selectively allows the fueling compartment to be opened and closed or the fueling flap or tank closure element to be flipped open and closed in relation to the fueling compartment, and thus allows access to the tank filler-neck.

The terms “fueling flap” and “fueling compartment” as used herein are not understood to mean only the components associated with a fueling or the components necessary for filling a fuel tank. Rather, these terms are also intended to include components for a tank for receiving other resources, for example AdBlue or urea, or an additive such as water. Accordingly, the disclosure also relates to actuating mechanisms for actuating service flaps associated with a filling system for a resource or additive fueling, in particular a fuel, AdBlue, or water tank.

Actuating mechanisms and actuating apparatuses for opening and closing a cover in or on a vehicle are generally known from the prior art, for example from DE 10 2008 057 933 B4, DE 10 2009 060 119 A1, DE 10 2011 101 838 A1, and DE 10 2012 004 078 A1.

In the prior art, however, there is a fundamental need for charging, fueling, or service compartment systems in which multiple functions must be switched and actuated in a coordinated manner. These functions include the unlocking and locking or releasing and blocking of the cover or charging, fueling, or service flap with the aid of a flap lock, moving the unlocked charging, fueling, or service flap relative to the charging, fueling, or service compartment such that the charging, fueling, or service flap is transferable from a closed position into an open position (and vice versa), and other functions such as enabling or disabling a light source for illuminating at least one region of the charging, fueling, or service compartment in its open state.

### SUMMARY

The present disclosure relates generally to an actuating mechanism, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in an isometric view, an exemplary aspect of the actuating mechanism according to the disclosure with a charging, fueling, or service flap.

FIG. 2 illustrates schematically, details of the actuating mechanism according to FIG. 1.

FIG. 3 illustrates schematically, details of the actuating mechanism according to FIG. 1.

FIG. 4 illustrates schematically and in an isometric view, details of the kinematics of the actuating mechanism according to FIG. 1.

FIG. 5 illustrates schematically and in an isometric view, the drive shaft having the (first) pinion and the integrated overload coupling of the kinematics shown in FIG. 4.

FIG. 6 illustrates schematically and in an isometric view, the drive shaft with the drive-side coupling element of the overload coupling of the kinematics according to FIG. 4.

FIG. 7 illustrates schematically and in an isometric view, the output-side coupling element of the overload coupling integrated into the drive shaft of FIG. 5.

FIG. 8A-C illustrates respectively schematically and in an isometric view, an alternative aspect of the drive shaft with an integrated overload coupling.

FIG. 9 illustrates in a schematic and isometric view, the input-side coupling element of the overload coupling of the kinematics according to FIG. 4.

FIG. 10 illustrates schematically and in a plan view of the front toothing of the drive-side coupling element according to FIG. 9.

FIG. 11 illustrates schematically and in an isometric view, the output-side coupling element of the overload coupling of the kinematics according to FIG. 4.

FIG. 12 illustrates shows a schematic view of the front toothing of the output-side coupling element according to FIG. 11.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates generally to actuating apparatuses for opening and closing a cover in or on a vehicle. In particular, the disclosure relates to a corresponding kinematics for actuating apparatuses for opening and closing a cover in or on a vehicle, wherein the kinematics is equipped with a self-actuating torque-switching safety coupling, which protects an electromotive actuator of the actuating apparatus against damage in the event of overload.

The present disclosure further relates to locking devices for locking covers in or on a housing, in particular of a vehicle body. Specifically, the disclosure relates to locking mechanisms for actuating a cover, in particular configured as a charging, fueling, or service flap, in a charging, fueling, or service compartment that is or can be received on or in a body component of a vehicle.

Furthermore, the disclosure relates to a corresponding system having a cover, in particular in the form of a charging, fueling, or service flap, and a charging, fueling, or service compartment, which is or can be received on or in a body component of a vehicle, wherein the cover (i.e., the charging, fueling, or service flap in particular) is reversibly movable between a closed position and an open position in relation to the charging, fueling, or service compartment and wherein it comprises a locking device for locking a charging, fueling, or service flap.

Finally, the disclosure further relates to a vehicle having such a system.

These different functions or functional components of the charging, fueling, or service compartment system must be controlled or manipulated in coordination with respect to time. For example, during a charging operation, it is first necessary to unlock the charging, fueling, or service flap in its closed position with the aid of the flap lock of the charging, fueling, or service compartment system, wherein the charging, fueling, or service flap can be moved relative to the charging, fueling, or service compartment only after the unlocking of the charging, fueling, or service flap in order to transfer it into the open state. Only then can the charging port or charging connector be connected and thereafter locked.

In order to manipulate and coordinate these functions or functional components, it is common to associate multiple actuators with the charging, fueling, or service compartment system, wherein each actuator takes over the actuation of a correspondingly associated functional component, such as triggering the flap lock and moving the unlocked charging, fueling, or service flap relative to the charging, fueling, or service compartment. In order to coordinate the actuation of the various functional components of the charging, fueling, or service compartment system, a control device is typically used, which triggers the respective actuators in a coordinated manner.

On the other hand, such charging, fueling, or service compartment systems, particularly during charging, are subjected to a variety of weather conditions, which can lead to sealing problems due to the functional components mentioned above. Individual components such as the charging, fueling, or service flap, can also become iced.

Accordingly, according to one aspect, the underlying problem of the disclosure is to further develop a locking device for charging, fueling, or service flaps in such a way that it has a relatively small construction space requirement, wherein at the same time several functions or functional components of the charging or fueling compartment system can be controlled in a reliable and coordinated manner. In addition, the aim is for the locking device to remain usable even when the charging, fueling, or service flap becomes iced.

On the other hand, in the case of motor-actuatable charging, fueling, or service flaps, there is a risk of damage to the drive and in particular the kinematics associated with the drive when attempting to manually move the charging, fueling, or service flap from its open position into its closed position, for example. This is particularly true when the drive is configured as a self-inhibiting drive.

Thus, according to a further aspect, the underlying problem of the disclosure is to further develop an actuating mechanism of the aforementioned type in such a way that potential damage to the drive and/or the kinematics is reliably prevented when, for example, the charging, fueling, or service flap is moved manually from its open position into its closed position.

In particular, according to the disclosure, one aspect of the task is to ensure that, in the case of an actuating mechanism, in particular of the type mentioned at the beginning, which is provided with an overload coupling, a control device of a drive of the actuating mechanism also then clearly “recognizes” a position of a charging, fueling or service flap, even if, due to the overload coupling, a form-fit lock and/or force-fit lock between the drive and a movement mechanism of the charging, fueling or service compartment has previously been released in the event of an overload.

Accordingly, it in particular relates to an overload coupling for an actuating mechanism for actuating a charging, fueling, or service flap on a charging, fueling, or service compartment that is or can be received on or in a body component of a vehicle, wherein the overload coupling comprises a drive-side coupling element and an output-side coupling element and is configured to, in an engaged state by means of a form-fit and/or force-fit lock, transfer a torque and thus a drive movement from the drive-side coupling element to the output-side coupling element, and, when a critical torque to be transferred is reached or exceeded in the event of an overload, to lift the form-fit and/or force-fit lock between the drive-side coupling element and the output-side coupling element.

The overload coupling according to the aspect of the disclosure is in particular designed as a sliding coupling, in which the drive-side coupling element and the output-side coupling element together form the coupling halves of a gear coupling. In the tooth coupling formed in this way, the drive-side coupling element and the output-side coupling element can be rotated together about an axis of rotation when the overload coupling is engaged.

In order to ensure a clear correlation between an actuator position and a flap position, the disclosure provides in particular that the drive-side coupling element is provided with a first front toothing on a side facing the output-side coupling element, and the output-side coupling element is provided with a second front toothing on a side facing the drive-side coupling element, wherein the first front toothing are designed at least partially and/or in certain regions to be complementary to the second front toothing in such a way that the two front toothings can engage in one another only when the drive-side coupling element has a unique and predetermined rotational position with respect to the output-side coupling element.

Various realizations are conceivable for this. Preferably, the first front toothing of the drive-side coupling element has a plurality of claw-shaped first teeth and at least one claw-shaped second tooth, wherein the first teeth with regard to size and/or shape, and wherein the at least one second tooth of the first front toothing differs from each of the first teeth of the first front toothing, in particular with regard to size and/or shape.

In this context, it is advantageous for the second front toothing of the output-side coupling element to have a plurality of first tooth gaps and at least one second tooth gap, wherein each first tooth gap of the plurality of first tooth gaps is complementary, at least in part or in some regions, to a first tooth of the first front toothing of the drive-side coupling element and the at least one second tooth gap of the second front toothing of the output-side coupling element is designed to be at least partially or in part complementary to the at least one second tooth of the first front toothing of the drive-side coupling element.

According to the design variants, the first teeth of the first front toothing of the drive-side coupling element and the first tooth gaps of the second front toothing of the output-side coupling element, as well as the at least one second tooth of the first front toothing of the drive-side coupling element and the at least one second tooth gap of the second front toothing of the output-side coupling element are designed in such a way that the first teeth of the first front toothing of the drive-side coupling element can be received, at least partially or in some areas, in the first tooth gaps of the second front toothing of the output-side coupling element and the at least one second tooth of the first front toothing of the drive-side coupling element can be received, at least partially or in certain areas, in the at least one second tooth gap of the second front toothing of the output-side coupling element only if the drive-side coupling element has the unambiguous and predetermined rotational position with respect to the output-side coupling element.

According to the realizations of the disclosure-based overload coupling, it is intended that the first teeth of the first front toothing of the drive-side coupling element have a configuration that is at least essentially trapezoidal in cross-section. Alternatively, and in particular in addition to this, it is preferred that the at least one second tooth of the first front toothing of the drive-side coupling element also has a configuration that is at least essentially trapezoidal in cross-section.

Of course, other designs are also possible for the teeth of the first front toothing of the drive-side coupling element.

According to the design variants of the overload coupling according to the disclosure, it is envisaged that, when viewed from above, the first teeth of the first front toothing of the drive-side coupling element essentially have the shape of an isosceles trapezoid with a first height, wherein, seen in a plan view, the at least one second tooth of the first front toothing of the drive-side coupling element also has the shape of an isosceles trapezoid, but this time with a second height, which is different and greater than the first height.

According to the realizations of the disclosure-based overload coupling, it is envisaged that the coupling element on the drive side is or can be actively connected to a drive shaft of a drive, wherein the output-side coupling element is or can be actively connected to a movement mechanism for moving and in particular pivoting the charging, fueling or service flap as required.

According to a further aspect of the disclosure, which can be combined as desired with the aforementioned aspect of the disclosure, the overload coupling is in particular a self-actuating torque-switching overload coupling for an actuating mechanism for actuating a charging, fueling, or service flap on a charging, fueling, or service compartment that is or can be received on or in a body component of a vehicle, wherein the overload coupling comprises a drive-side coupling element and an output-side coupling element and is configured to, in an engaged state by means of a form-fit and/or force-fit lock, transfer a torque and thus a drive movement from the drive-side coupling element to the output-side coupling element, and, when a critical torque to be transferred is reached or exceeded in the event of an overload, to lift the form-fit and/or force-fit lock between the drive-side coupling element and the output-side coupling element.

With the overload coupling according to the disclosure, potential damage to the drive and/or the kinematics of an actuating mechanism for actuating a charging, fueling, or service flap is prevented in an easily implemented but nevertheless effective manner when, for example, the charging, fueling, or service flap is moved manually from its open position into its closed position. In addition, the overload coupling serves as a safety in the event of an icing of the charging, fueling, or service flap, if it must be opened despite icing by means of an electromotive drive.

The overload coupling according to the disclosure is characterized by its compact and design space-saving structure.

According to one realization of the overload coupling according to the disclosure, the drive-side coupling element or the output-side coupling element and preferably the drive-side coupling element comprises a center bearing pin on which the other coupling element and preferably the output-side coupling element is supported.

Advantageously, the overload coupling according to the disclosure is configured as a slip coupling, in which the drive-side coupling element and the output-side coupling element together form the coupling halves of a toothed coupling. In particular, it is provided that the drive-side coupling element and the output-side coupling element are equipped, on the sides facing one another, with a front toothing that engage or can engage with one another in a form-fit lock.

Advantageously, the overload coupling further comprises a power accumulator, for example in the form of a spring element, with which the drive-side or the output-side coupling element is stressed in such a way that, upon reaching or exceeding the critical torque, the drive-side coupling element and the output-side coupling element are rotatable in relation to one another.

The power accumulator preferably comprises at least one spring element, in particular in the form of a compression spring or in the form of a poppet spring, which is mounted on the center bearing pin.

In this context, it is conceivable that a counter-bearing element, which is in particular washer-shaped or plate-shaped, is arranged on an end region of the center bearing pin that faces away from the drive-side coupling element, and wherein the at least one spring element is mounted on the center bearing pin in such a way that an end region of the spring element facing away from the drive-side coupling element impacts the in particular washer-shaped or plate-shaped counter-bearing element.

Preferably, the drive-side coupling element is configured as a washer-shaped or plate-shaped element on a first end region of a drive shaft, wherein a second end region of the drive shaft opposite the first end region of the drive shaft is or can be operatively connected to a drive, in particular to an electromotive drive. In particular, it is provided that a front face of the washer-shaped or plate-shaped element facing away from the first end region of the drive shaft is equipped with a front toothing.

According to implementations of the overload coupling according to the disclosure, which is formed in particular by a small number of components and with particularly compact dimensions, it is provided that the center bearing pin is arranged concentrically in relation to a longitudinal and/or rotational axis of the drive shaft and is preferably configured integrally (i.e., in one piece) with the drive-side coupling element and/or the drive shaft. In this context it is conceivable that the center bearing pin is formed together with the drive shaft in an injection molding process.

The output-side coupling element can have an in particular washer-shaped or plate-shaped region with an in particular center passage through which the center bearing pin is guided. It can be appreciated that an end region of the at least one spring element of the power accumulator facing the drive-side coupling element impacts the in particular washer-shaped or plate-shaped region of the output-side coupling element.

Here, too, it is advantageous that a lateral face of the in particular washer-shaped or plate-shaped region of the output-side coupling element facing away from the at least one spring element is equipped with a front toothing.

According to preferred implementations of the overload coupling according to the disclosure, it is provided that the front toothing of the drive-side coupling element and the output-side coupling element is formed from trapezoidal teeth and corresponding tooth gaps in cross-section. Of course, other aspects can also be considered here.

Particularly preferably, it is provided that the output-side coupling element is configured as a sleeve-shaped body, wherein an outer toothing is formed at least regionally on an outer lateral surface of the sleeve-shaped body.

The disclosure is not limited to overload couplings configured as slip couplings. It is conceivable, for example, that the overload coupling according to the disclosure is configured as a blocking body coupling in which a spring-stressed torque transfer body of the drive-side coupling element or the output-side coupling element reversibly slips out of a corresponding receptacle of the output-side coupling element or the drive-side coupling element upon reaching or exceeding the critical torque.

In this context, it is conceivable, for example, that the torque transfer body of the overload coupling configured as a blocking body coupling is configured as a ball end, which is connected to the drive-side coupling element, wherein the output-side coupling element comprises a receiving region for at least partially or regionally receiving, in particular receiving in a form-fit lock, a region of the torque transfer body (the ball end), wherein, in the engaged state of the overload coupling, the torque transfer body is operatively connected to the output-side coupling element via the receiving region, and wherein, in the disengaged state of the overload coupling, the torque transfer body no longer engages with the receiving region of the output-side coupling element and is no longer operatively connected to the drive-side coupling element via the receiving region of the output-side coupling element.

The underlying problem of the disclosure is further solved by an actuating mechanism according to the parallel claim 14.

The actuating mechanism serves to actuate a charging, fueling, or service flap on a charging, fueling, or service compartment that is or can be received on or in a body component of a vehicle, wherein the charging, fueling, or service flap is reversibly movable, and in particular pivotable, between a closed position and an open position in relation to the charging, fueling, or service compartment.

The actuating mechanism a drive in the form of an electromotive drive and a kinematics associated with the drive and configured to tap a rotational movement of the drive when the drive is actuated and convert it into a first movement for manipulating, and in particular pivoting, the charging, fueling, or service flap. According to the present disclosure, it is provided in particular that the kinematics comprises an overload coupling of the type described above.

The actuating mechanism according to the disclosure can further comprise a flap lock for locking the charging, fueling, or service flap in its closed position, wherein the flap lock has a locking position in which the flap lock locks the charging, fueling, or service flap and a release position in which the charging, fueling, or service flap can be moved in relation to the flap lock.

According to design variants, the kinematics associated with the drive can be configured to tap a rotational movement of the drive when the drive is actuated and convert it into a first movement for manipulating, and in particular pivoting, the charging, fueling, or service flap and into a second movement for manipulating the flap lock.

Preferably, the kinematics is configured to tap the rotational movement of the drive or a drive shaft associated with the drive for the movement to open the charging, fueling, or service flap only when the flap lock has been transferred into its release position by the second movement.

According to a preferred implementation of the actuating mechanism according to the disclosure, it further comprises a first transfer shaft connected to the flap lock such that the flap lock can be moved, in particular pivotable, by a movement, in particular a rotation, of the first transfer shaft between the locking position and the release position.

In addition, the actuating mechanism comprises a pushing element, which is connected to the first transfer shaft and configured to push the charging, fueling, or service flap out of its closed position away from the charging compartment, namely after the flap lock has been transferred into its release position.

By connecting the pushing element and the flap lock to a common first transfer shaft, a synchronized unlocking and pushing out of the charging, fueling, or service flap can be achieved. The pushing element serves primarily to also push out the charging, fueling, or service flap against a resistance. Thus, any icing of the charging, fueling, or service flap can preferably also be broken up by the pushing element. With the synchronization via the first transfer shaft, it is also achieved that the charging, fueling, or service flap can only be pushed out when the lock has been transferred into its release position and thus releases the flap. Thus, it generally cannot occur that the pushing element will push against the charging, fueling, or service flap when it is still locked by the flap lock.

The pushing element is further configured to push the charging, fueling, or service flap out of its closed position away from the charging, fueling, or service compartment when the first transfer shaft is further moved, in particular rotated, in the first direction upon reaching the release position of the flap lock. Thus, no other movement of the first transfer shaft is needed in order to push the charging, fueling, or service flap with the pushing element in the direction of its open position. Rather, this is automatically achieved by continuing to rotate the first transfer shaft after unlocking the charging, fueling, or service flap. According to an exemplary aspect, the pushing element can also be attached directly on the first transfer shaft.

Preferably, the pushing element and the flap lock are integrally formed. In other words, the actuating mechanism can comprise a single component for locking and pushing out the fueling, charging, or service flap. This can be attached to the first transfer shaft with a single opening. According to a further aspect, the space requirement of the flap lock is particularly low.

It is conceivable in particular that the flap lock is configured as a locking hook, wherein the locking hook is configured to be in operating engagement with the charging, fueling, or service flap, in particular with a locking element of the charging, fueling, or service flap, in the locking position, preferably in a friction-locking manner. By using a locking hook, the charging, fueling, or service flap can be easily secured against undesired pivoting, for example during travel. On the other hand, other aspects for the flap lock, such as bolts or the like, are conceivable.

The actuating mechanism according to the disclosure has in a particular dual function: on the one hand, the actuating mechanism serves to lock the charging, fueling, or service flap and to push it out it in the event of icing. On the other hand, the actuating mechanism also serves to actively move the charging, fueling, or service flap between the closed position and the open position. The kinematics used is configured to synchronize the movement of the flap lock and the charging, fueling, or service flap with one another.

In this context, it is conceivable in particular that the kinematics is configured to tap the rotational movement of the drive for the first movement to open the charging, fueling, or service flap only when the flap lock has been transferred into its release position by the second movement.

Thus, it is prevented that the drive will attempt to open the charging, fueling, or service flap when the flap lock is still in its locking position. Only when the flap lock is unlocked, that is to say it has been transferred into its release position, the kinematics converts the rotational movement of the drive into a movement for opening the charging, fueling, or service flap.

According to aspects of the actuating mechanism according to the disclosure, the kinematics is configured to transfer the rotational movement of the drive to the first transfer shaft in order to move the flap lock between the locking position and the release position, wherein the actuating mechanism comprises a second transfer shaft, which is or can be connected to the charging, fueling, or service flap in such a way that the charging, fueling, or service flap can be moved, in particular pivotable, between the closed position and the open position by a rotation of the second transfer shaft.

Here, it can be appreciated that the kinematics of the actuating mechanism is configured to transfer the rotational movement of the drive to the second transfer shaft. The kinematics selectively transfers the kinetic energy of the drive to two different transfer shafts. The first transfer shaft is used in order to actuate the flap lock and the pushing element, as described above. The second transfer shaft serves to move the charging, fueling, or service flap between the open and closed positions. Thus, for example, it can also be achieved that the flap lock and the charging, fueling, or service flap can be moved, and in particular pivoted, at different speeds.

The overload coupling is associated in particular with the kinematics of the actuating mechanism and serves to disengage the drive from the second transfer shaft as soon as a resistance against the first movement exceeds a threshold value. The kinematics is configured to continue transferring the rotational movement of the drive to the first transfer shaft if the threshold value is exceeded (overload). According to this design variant, an unintended opening of the charging, fueling, or service flap against too high a resistance is prevented, whether due to icing or a non-closing] lap lock.

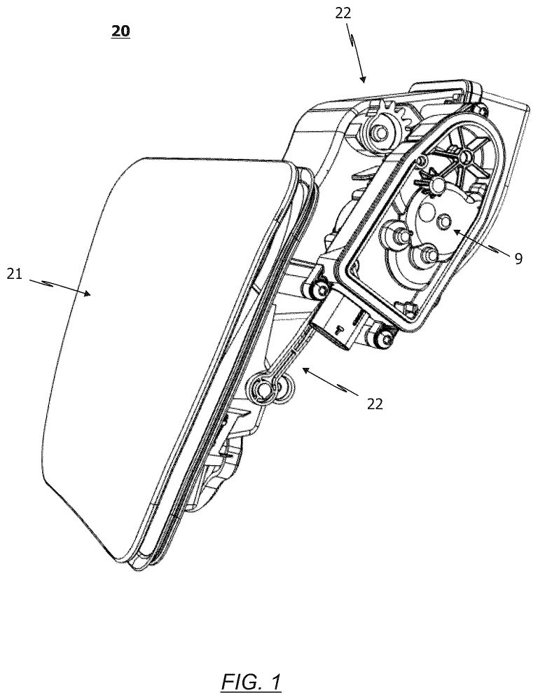

FIG. 1 shows, schematically and in an isometric view, an actuating mechanism 20 according to an aspect of the present disclosure. The actuating mechanism 20 of the design variant shown serves on the one hand to actuate a cover shown herein as a charging flap 21. On the other hand, the actuating mechanism 20 is also configured to lock the charging flap 21 in its closed position shown in FIG. 1. Finally, icing of the charging flap 21 can be broken up by the actuating mechanism 20 on the associated charging, fueling, or service compartment 35.

The actuating mechanism 20 comprises a drive 9 in the form of an electromotive drive 9. A rotation of the electromotive drive 9 is transferred via a kinematics 22 to the corresponding movable elements of the actuating mechanism 20, such as to a flap lock 33 and/or to a pivot arm 39 for the charging flap 21.

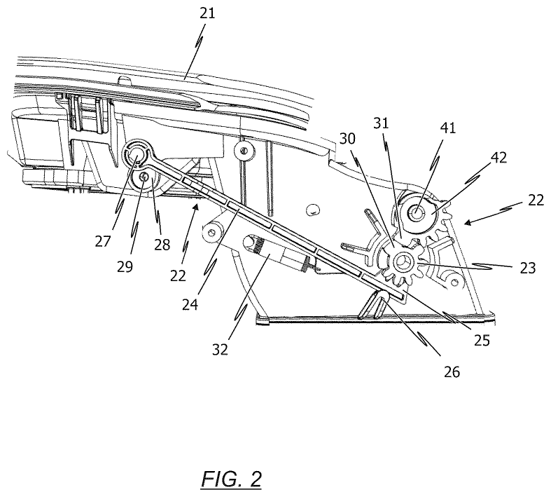

A detailed view of the kinematics 22 of the actuating mechanism 20 can be seen in the illustration in FIG. 2.

As indicated, the kinematics 22 comprises a first pinion 23, which is operatively connected to the electromotive drive 9 of the actuating mechanism 20 via a drive shaft 8. A rotation of the electromotive drive 9 can be transferred to the first pinion 23 via the drive shaft 8.

The first pinion 23 is connected to a gear rack 24. In particular, the first pinion 23 is connected to a first end region 25 of the gear rack 24. For this purpose, the first end region 25 of the gear rack 24 comprises one or more teeth that are operatively connected to corresponding teeth of the first pinion 23. By way of an elastic counter-bearing 26, shown schematically in FIG. 2, the first end region 25 of the gear rack 24 is pressed against the first pinion 23 such that it is operatively connected at all times to the teeth of the first pinion 23.

At a second end region 27 of the gear rack 24 opposite the first end region 25 of the gear rack 24, the gear rack 24 is rotatably connected to an eccentric washer 28. The eccentric washer 28 is connected to a first transfer shaft 29. The first transfer shaft 29 extends in particular into the interior of the charging, fueling, or service compartment 35, which is not shown here.

The first pinion 23 is operatively connected to a second pinion 42. In particular, the second pinion 42 has one or more teeth operatively connected to corresponding teeth of the first pinion 23. The second pinion 42 is arranged substantially at a side of the first pinion 23 lying opposite the first end region 25 of the gear rack 24.

The first pinion 23 and the second pinion 42 have respective stops 30, 31 that limit the maximum rotational angle of the pinions 23, 42. The first stop 30 of the first pinion 23 limits the maximum movement stroke, that is to say the maximum pivoting, of the flap lock 33. The second stop 31 of the second pinion 42 limits the maximum movement stroke, that is to say the maximum pivoting, of the charging flap 21.

The second pinion 42 can be connected to a second transfer shaft 41 via an overload coupling 1, not shown here. The second transfer shaft 41 serves to transfer a rotational energy of the drive 9 to the charging flap 21 in order to move it from its closed position into its open position (and back).

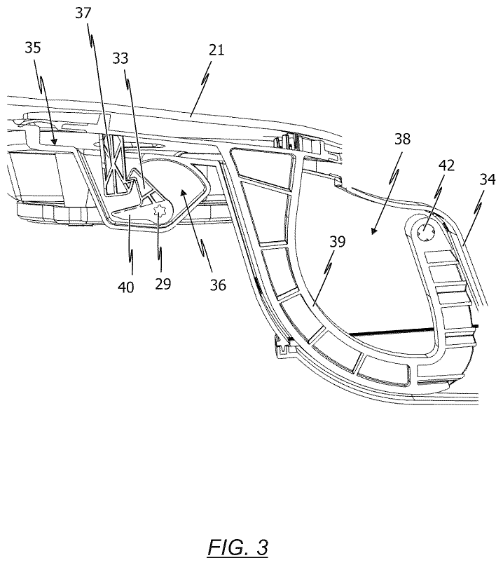

The kinematics 22 is biased into the position shown in FIG. 2. A biasing element 32 configured as a spring serves for this purpose. The biasing element 32 is connected to a housing 34 of the actuating mechanism 20 on the one hand and to the gear rack 24 on the other hand. The resting position of the gear rack 24 shown in FIG. 2 corresponds to a locking position of flap lock 33 (FIG. 3). In other words, the biasing element 32 biases the flap lock 33 into its locking position.

A cross-sectional view through the housing 34 of the actuating mechanism 20 is shown schematically in FIG. 3. A charging, fueling, or service compartment 35 (hereinafter also referred to simply as the “charging compartment”) is provided on a front side of the housing 34. Behind the charging compartment 35, i.e., on the side of the charging compartment 35 facing away from the charging, fueling, or service flap 21, a first cavity 36 is configured to receive a flap lock 33 and a second cavity 38 is configured to receive a pivot arm 39.

The flap lock 33 received in the first cavity 36 is connected to the first transfer shaft 29 and has a locking position, shown in FIG. 3, in which the flap lock 33 locks the charging, fueling, or service flap in its closed position, shown in FIG. 3. For this purpose, the flap lock 33 is connected to a locking element 37 of the charging flap 21. In particular, the flap lock 33 and the locking element 37 are respective locking hooks that are operatively connected to one another in the closed position of the flap lock 33.

As indicated above in connection with FIG. 2, the flap lock 33 is biased into the locking position shown in FIG. 3 by the biasing element 32. To unlock the flap lock 33 and thus transfer the flap lock 33 into its unlocking position, the first pinion 23 is rotated by the drive 9 in a counter-clockwise direction, as shown in FIG. 2. The first pinion 23 is operatively connected to teeth arranged at the first end region 25 of the gear rack 24 such that, as the first pinion 23 rotates, the gear rack 24 is pulled counterclockwise in the direction of the first end region 25 of the gear rack 24. Via the second end region 27 of the gear rack 24, which is connected to the eccentric washer 28, such a pulling movement of the gear rack 24 is transferred to the first transfer shaft 29. Accordingly, the first transfer shaft 29 is rotated clockwise according to FIG. 2.

In other words, rotating the first pinion 23 in one direction, for example counterclockwise, as shown in FIG. 2, causes the first transfer shaft 29 to rotate in the opposite direction, for example clockwise, as shown in FIG. 2.

Returning to the illustration according to FIG. 3, it should be mentioned that a rotation of the first transfer shaft 29 in the clockwise direction also causes the flap lock 33 to be pivoted clockwise. In particular, the flap lock 33 is pivoted away from the locking element of the charging flap 21 in the first direction shown as clockwise and into the interior of the first cavity 36.

By pivoting the flap lock 33 in the first direction, it is released from the locking element and thus releases a movement of the charging flap 21. As soon as the flap lock 33, which is configured as a locking hook, is no longer in operating engagement with the locking element, the flap lock 33 has reached its release position.

The actuating mechanism 20 further comprises a pushing element 40 that serves to push the charging, fueling, or service flap 21 away from the charging compartment 35 out of the closed position shown in FIG. 2 in the event that the charging, fueling, or service flap 21 should become stuck in the closed position, for example, upon icing. The pushing element 40 is connected to the first transfer shaft 29. The pushing element 40 is arranged on the first transfer shaft 29 such that it only comes into contact with the locking element after the flap lock 33 has already been transferred into its release position.

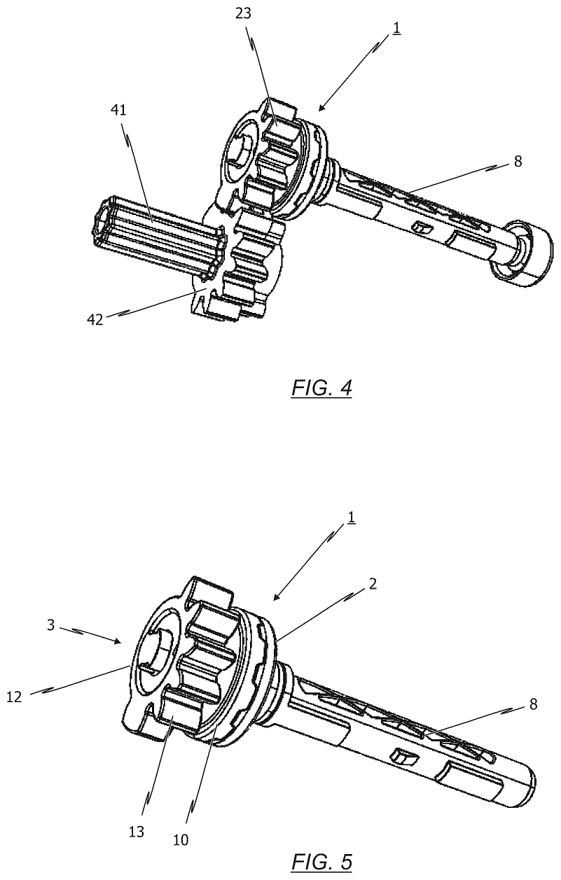

FIG. 4 shows, schematically and in an isometric view, the drive shaft 8 with the first pinion 23 of the kinematics 22, wherein the first pinion 23 of the drive shaft 8 is operatively connected to the second transfer shaft 41 via a second pinion 42. It can be seen that the first pinion 23 is connected to the drive shaft 8 via an overload coupling 1.

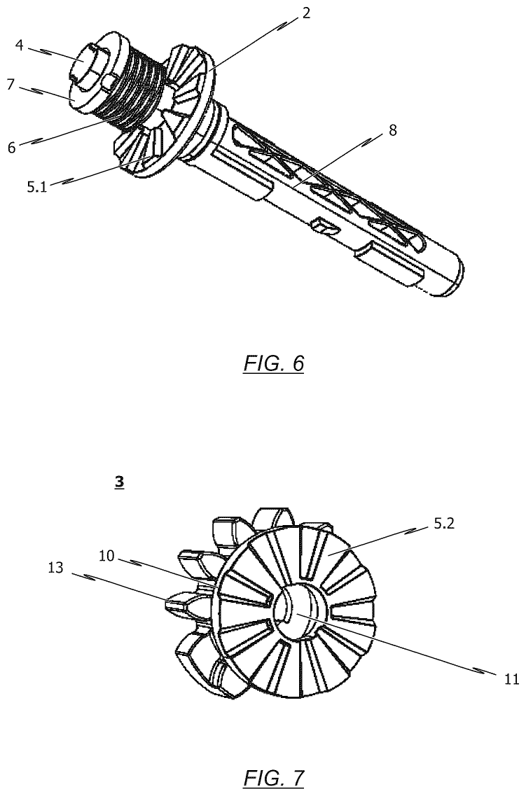

FIG. 5 shows, schematically and in an isometric view, a portion of the drive shaft 8 with the integrated overload coupling 1 and the first pinion 41, while FIG. 6 shows the drive shaft 8 with the drive-side coupling element 2 of the overload coupling 1.

In FIG. 7, schematically and in an isometric view, the output-side coupling element 3 of the overload coupling 1 of the drive shaft 8 is shown.

Referring now to the illustrations in FIG. 4 through FIG. 7, an exemplary aspect of an overload coupling 1 that can be used in the actuating mechanism 20 according to FIG. 1 will be described in further detail below.

Specifically, FIG. 4 show, schematically and in an isometric view, a portion of the kinematics 22 of the actuating mechanism 20 according to FIG. 1, namely in detail the drive shaft 8 with the first pinion 23, which is operatively connected to a second transfer shaft 41 via a second pinion 42 with. The drive shaft 8 of the kinematics 22 with the first pinion 23 and the integrated overload coupling 1 is shown again in FIG. 5.

FIG. 6 schematically shows the drive-side coupling element 2 of the overload coupling 1 integrated in the drive shaft 8, while FIG. 7 shows, schematically and in an isometric view, the output-side coupling element 3 of the overload coupling 1.

Generally speaking, the overload coupling 1 comprises a drive-side coupling element 2 and an output-side coupling element 3 and is configured to, in an engaged state by means of a form-fit and/or force-fit lock, transfer a torque and thus a drive movement from the drive-side coupling element 2 to the output-side coupling element 3. When a critical torque to be transferred is reached or exceeded in the event of an overload, the form-fit and/or force-fit lock between the drive-side coupling element 2 and the output-side coupling element 3 is lifted.

Returning to the actuating mechanism 20, for example according to FIG. 1, such an overload case occurs, for example, when (for whatever reason), the second transfer shaft 41 is blocked, but the electromotive drive 9, which is operatively connected to the drive shaft 8, is nevertheless actuated.

As can in particular be seen in the illustration in FIG. 6, the drive-side coupling element 2 comprises a center bearing pin 4 on which the output-side coupling element 3 is mounted (cf. FIG. 5). The bearing pin 4 is configured to be concentric to the longitudinal and rotational axis of the drive shaft 8.

Specifically, the overload coupling 1 shown in FIG. 4 through FIG. 7 is configured as a slip coupling. The drive-side coupling element 2 and the output-side coupling element 3 together form the coupling halves of a toothed coupling. To this end, the drive-side coupling element 2—as can be seen, for example, in FIG. 6—and the output-side coupling element 3 (as can be seen, for example, in FIG. 7) have corresponding front toothings 5.1, 5.2 on the sides facing one another. In an engaged state, these front toothings 5.1, 5.2 engage and thus form an in particular form-fit lock between the drive-side coupling element 2 and the output-side coupling element 3.

It can further be seen from the view in FIG. 6 that the overload coupling 1 comprises a power accumulator in the form of a spring element 6. The spring element 6 is a compression spring, for example, or at least one poppet spring, which is mounted on the center bearing pin 4.

The at least one spring element 6 serves to stress the output-side coupling element 3 such that, upon reaching or exceeding the critical torque, the drive-side coupling element 2 together with the drive shaft 8, and the output-side coupling element 3 together with the first pinion 23 integrally arranged for this purpose, are rotatable in relation to one another.

It can further be seen from the isometric view in FIG. 6 that a washer-shaped or plate-shaped counter-bearing element 7 is arranged on an end region of the center bearing pin 4 facing away from the drive-side coupling element 2. In the assembled state of the overload coupling 1, the at least one spring element 6 is mounted on the center bearing pin 4 such that an end region of the at least one spring element 6 facing away from the drive-side coupling element 2 impacts the washer-shaped or plate-shaped counter-bearing element 7.

In the exemplary aspect of the overload coupling 1 according to the disclosure shown in FIG. 4 through FIG. 7, the drive-side coupling element 2 is configured as a washer-shaped or plate-shaped element at a first end region of the drive shaft 8. A second end region of the drive shaft 8 opposite the first end region of the drive shaft 8 is or can be operatively connected to a drive 9, in particular an electromotive drive 9, which is not explicitly shown in FIG. 4 through FIG. 7.

A lateral face of the washer-shaped or plate-shaped element of the drive-side coupling element 2 facing away from the second end region of the drive shaft 8 is equipped with the aforementioned front toothing 5.1.

The center bearing pin 4 is arranged concentrically in relation to a longitudinal and/or rotational axis of the drive shaft 8 and is preferably configured integrally with the drive-side coupling element 2 and the drive shaft 8.

As can be seen in the illustration in FIG. 7, the output-side coupling element 3 comprises an in particular washer-shaped or plate-shaped region 10 with an in particular center passage 11, through which the center bearing pin 4 is guided in the assembled state of the overload coupling 1. An end region of the at least one spring element 6 of the overload coupling 1 facing the drive-side coupling element 2 impacts the in particular washer-shaped or plate-shaped region 10 of the output-side coupling element 3.

It can also be seen in the illustration in FIG. 7 that a lateral face of the washer-shaped or plate-shaped region 10 of the output-side coupling element 3 facing away from the at least one spring element 6 is equipped with the aforementioned front toothing 5.2.

The front toothing 5.1 of the drive-side coupling element 2 and the output-side coupling element 3 is formed from trapezoidal teeth and corresponding tooth gaps in cross-section.

Still referring to FIG. 7, it can be seen that, in the exemplary aspect of the output-side coupling element 3 shown therein, it is configured as a sleeve-shaped body 12, wherein an outer toothing 13 is formed at least regionally on an outer lateral surface of the sleeve-shaped body 12, which ultimately forms at least a region of the first pinion 23.

The overload coupling 1 serves in particular to disengage the drive shaft 8 of the electromotive drive 9 in the event of an overload in order to avoid potential damage to the electromotive drive 9. In particular, the deployment and use of the overload coupling 1 is not limited to an actuating mechanism 20 as previously described with reference to the illustrations in FIG. 1 through FIG. 3.

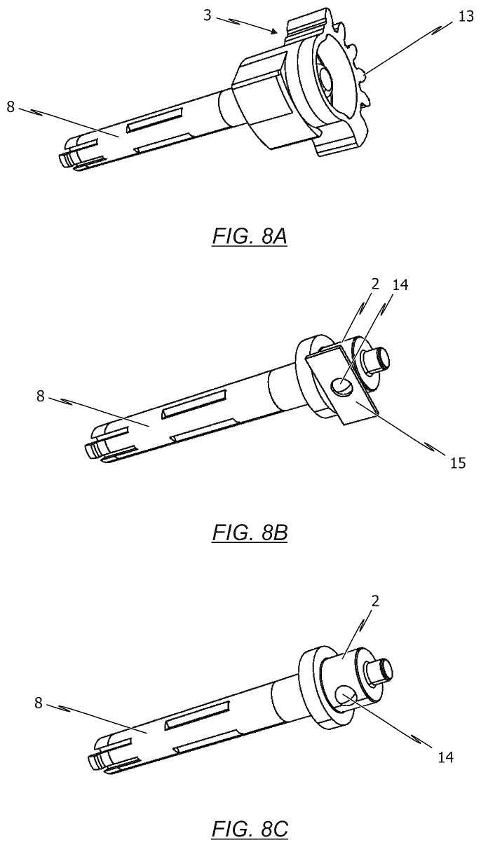

In FIG. 8A through FIG. 8C, an alternative aspect of the overload coupling 1 is shown.

Specifically, this alternative aspect of the overload coupling 1 is configured as a lock body coupling, in which a spring-stressed torque transfer body 14 of the drive-side coupling element 2 reversibly slips out of a corresponding receptacle 15 of the output-side coupling element 3 upon reaching or exceeding the critical torque.

In the aspect of the overload coupling 1 according to the disclosure as illustrated in FIG. 8A through FIG. 8C, the torque transfer body 14 is configured as a ball end, wherein other configurations are also possible for the torque transfer body 14.

The torque transfer body 14 is operatively connected to the drive-side coupling element 2, wherein the output-side coupling element 3 comprises a receiving region for receiving a region of the torque transfer body 14 at least partially or regionally, in particular in a form-fit manner.

In the engaged state of the overload coupling 1, the torque transfer body 14 is operatively connected to the output-side coupling element 3 via the receiving region.

In the disengaged state of the overload coupling 1, on the other hand, the torque transfer body 14 no longer engages with the receiving region of the output-side coupling element 3 and thus is also no longer operatively connected to the drive-side coupling element 2 via the receiving region of the output-side coupling element 3.

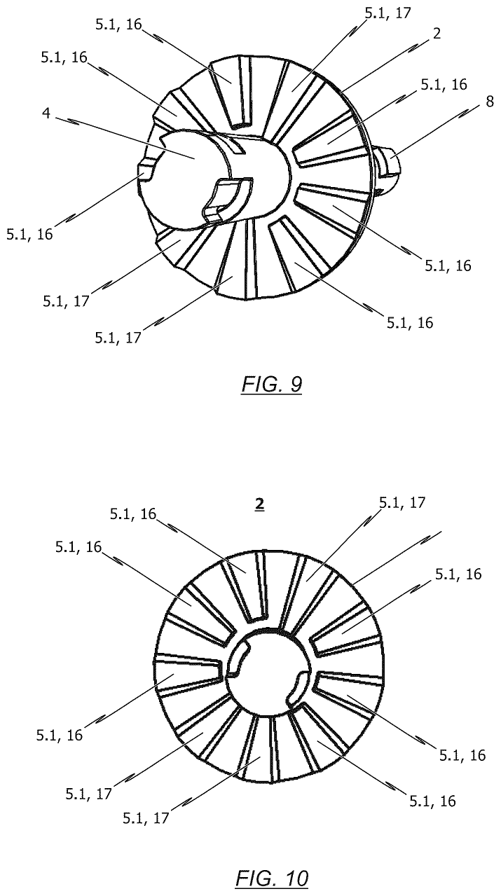

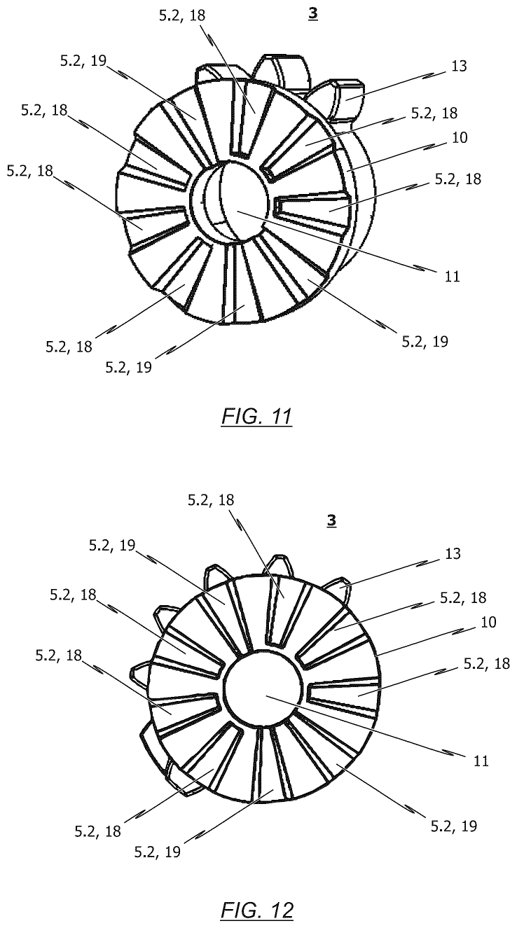

As can be seen in particular from the representations in FIG. 9 through FIG. 12, the drive-side coupling element 2 has a first front toothing 5.1 on a side facing the output-side coupling element 3, while the output-side coupling element 3 is provided with a second front toothing 5.2 on a side facing the drive-side coupling element 2.

The first front toothing 5.1 is designed to be so complementary, at least in part and/or in some areas, to the second front toothing 5.2 that the two front toothings 5.1, 5.2 can only engage with one another when the drive-side coupling element 2 has a unique and predetermined rotational position in relation to the output-side coupling element 3.

For this purpose, the first front toothing 5.1 of the drive-side coupling element 2 has a plurality of claw-shaped first teeth 16 and at least one claw-shaped second tooth 17, wherein the first teeth 16 are formed identically to one another, in particular with respect to size and/or shape, and wherein the at least one second tooth 17 of the first front toothing 5.1 differs from each of the first teeth 16 of the front toothing 5.1, in particular with respect to size and/or shape.

On the other hand, it is provided that the second front toothing 5.2 of the output-side coupling element 3 has a plurality of first tooth gaps 18 and at least one second tooth gap 19, wherein each first tooth gap 18 of the plurality of first tooth gaps 18 is at least partially or regionally complementary to a first tooth 16 of the first front toothing 5.1 of the drive-side coupling element 2 and the at least one second tooth gap 19 of the second front toothing 5.2 of the output-side coupling element 3 is at least partially or partially complementary to the at least one second tooth 17 of the first front toothing 5.1 of the drive-side coupling element 2.

In particular, it is envisaged that the first teeth 16 of the first front toothing 5.1 of the drive-side coupling element 2 and the first tooth gaps 18 of the second front toothing 5.2 of the output-side coupling element 3, as well as the at least one second tooth 17 of the first front toothing 5.1 of the drive-side coupling element 2 and the at least one second tooth gap 19 of the second front toothing 5.2 of the output-side coupling element 3 are designed in such a way that the first teeth 16 of the first front toothing 5.1 of the input-side coupling element 2 are only then at least partially or zonally in the first tooth gaps 18 of the second front toothing 5.2 of the output-side coupling element 3 and the at least one second tooth 17 of the first front toothing 5.1 of the drive-side coupling element 2 can be received, at least partially or in regions, in the at least one second tooth gap of the second front toothing 5.2 of the output-side coupling element 3 only when the drive-side coupling element 2 has the unambiguous and predetermined rotational position with respect to the output-side coupling element 3.

As shown, the first teeth 16 of the first front toothing 5.1 of the drive-side coupling element 2 can have a configuration that is at least essentially trapezoidal in cross-section. In the same way, the at least one second tooth 17 of the first front toothing 5.1 of the drive-side coupling element 2 can have a configuration that is at least essentially trapezoidal in cross-section.

The above-cited patents and patent publications are hereby incorporated by reference in their entirety. While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMBERS

1 Overload coupling
2 Drive-side coupling element
3 Output-side coupling element
4 Center bearing pin
5.1, 5.2 first/second front toothing
6 Power accumulator/spring element
7 Counter-bearing element
8 Drive shaft
9 Drive
10 Washer-shaped or plate-shaped region of the output-side coupling element
11 Center passage of the output-side coupling element
12 Sleeve-shaped body of the output-side coupling element
13 Outer toothing
14 Torque transfer body/ball end
15 Receptacle/receiving region of the output-side coupling element
16 First teeth of the first front toothing
17 Second tooth of the first front toothing
18 First tooth gap of the second front toothing
19 Second tooth gap of the second front toothing
20 Actuating mechanism
21 Charging, fueling, or service flap
22 Kinematics
23 First pinion
24 Gear rack
25 First end region of the gear rack
26 Elastic counter-bearing
27 Second end region of the gear rack
28 Eccentric washer
29 First transfer shaft
30 First stop of the first pinion
31 Second stop of the second pinion
32 Biasing element/spring
33 Flap lock
34 Housing of the actuating mechanism
35 Charging, fueling, or service compartment
36 First cavity
37 Locking element
38 Second cavity
39 Pivot arm
40 Pushing element
41 Second transfer shaft
42 Second pinion

What is claimed is:

1. An overload coupling (1) for an actuation mechanism (20) for actuating a charging, fueling or service flap (21) on a charging, fueling or service compartment (35) received or receivable on or in a bodywork component of a vehicle, the overload coupling (1) comprising:
a drive-side coupling element (2) and an output-side coupling element (3) configured, in an engaged state, to transmit a torque and thus a drive movement from the drive-side coupling element (2) to the output-side coupling element (3) by positive and/or frictional engagement, and to release the positive and/or frictional engagement between the drive-side coupling element (2) and the output-side coupling element (3) when a critical torque to be transmitted is reached or exceeded in an event of an overload,
wherein the overload coupling (1) is designed as a slip coupling, in which the drive-side coupling element (2) and the output-side coupling element (3) together form coupling halves of a toothed coupling, and in which, in the engaged state of the overload coupling (1), the drive-side coupling element (2) and the output-side coupling element (3) can be rotated together about an axis of rotation,
wherein the drive-side coupling element (2) is provided on a side facing the output-side coupling element (3) with a first front toothing (5.1) and the output-side coupling element (3) is provided on a side facing the drive-side coupling element (2) with a second front toothing (5.2), wherein the first front toothing (5.1) is designed at least partially and/or in certain regions to be complementary to the second front toothing (5.2) in such a way that the first and second front toothings (5.1, 5.2) can engage in one another only when the drive-side coupling element (2) has a unique and predetermined rotational position with respect to the output-side coupling element (3).

2. The overload coupling (1) according to claim 1, wherein the first front toothing (5.1) of the drive-side coupling element (2) has a plurality of claw-shaped first teeth (16) and at least one claw-shaped second tooth (17), wherein the first teeth (16) are, with regard to size and/or shape, and wherein the at least one second tooth (17) of the first front toothing (5.1) differs with regard to size and/or shape from each of the first teeth (16) of the first front toothing (5.1).

3. The overload coupling (1) according to claim 2, wherein the second front toothing (5.2) of the output-side coupling element (3) has a plurality of first tooth gaps (18) and at least one second tooth gap (19), wherein each first tooth gap (18) of the plurality of first tooth gaps (18) being complementary, at least in part or in regions, to a first tooth (16) of the first front toothing (5.1) of the drive-side coupling element (2) and the at least one second tooth gap (19) of the second front toothing (5.2) of the output-side coupling element (3) is designed at least partially or in part complementary to the at least one second tooth (17) of the first front toothing (5.1) of the drive-side coupling element (2).

4. The overload coupling (1) according to claim 3, wherein the first teeth (16) of the first front toothing (5.1) of the drive-side coupling element (2) and the first tooth gaps (18) of the second front toothing (5.2) of the output-side coupling element (3) as well as the at least one second tooth (17) of the first front toothing (5.1) of the drive-side coupling element (2) and the at least one second tooth gap (19) of the second front toothing (5.2) of the output-side coupling element (3) are designed in such a way that the first teeth (16) of the first front toothing (5.1) of the drive-side coupling element (2) are only then at least partially or in certain areas in the first tooth gaps (18) of the second front toothing (5.2) of the output-side coupling element (3) and the at least one second tooth (17) of the first front toothing (5.1) of the drive-side coupling element (2) can only be accommodated at least partially or in certain regions in the at least one second tooth gap of the second front toothing (5.2) of the output-side coupling element (3) if the drive-side coupling element (2) has a predetermined rotational position with respect to the output-side coupling element (3).

5. The overload coupling (1) according to claim 2,
wherein the first teeth (16) of the first front toothing (5.1) of the drive-side coupling element (2) have a configuration which is at least substantially trapezoidal in cross-section; or
wherein the at least one second tooth (17) of the first front toothing (5.1) of the drive-side coupling element (2) has a configuration which is at least substantially trapezoidal in cross section.

6. The overload coupling (1) according to claim 2, wherein, when viewed from above, the first teeth (16) of the first front toothing (5.1) of the drive-side coupling element (2) are substantially in the form of an isosceles trapezium having a first height, and wherein, when viewed from above, the at least one second tooth (17) of the first front toothing (5.1) of the drive-side coupling element (2) is essentially in the form of a isosceles trapezium with a second height, which is different from the first height.

7. The overload coupling (1) according to claim 1, wherein the drive-side coupling element (2) is operatively connected or connectable to a drive shaft of a drive (9), and wherein the output-side coupling element (3) is operatively connected or connectable to a movement mechanism for moving and pivoting the charging, fueling or service flap (21) as required.

8. The overload coupling (1) according to claim 1, wherein the drive-side coupling element (2) or the output-side coupling element (3) and preferably the drive-side coupling element (2) comprises a center bearing pin (4) on which the other coupling element and preferably the output-side coupling element (3) is supported.

9. The overload coupling (1) according to claim 1, wherein the overload coupling (1) also has an energy storage mechanism, with which the drive-side or the output-side coupling element (3) is loaded in such a way that when the critical torque is reached or exceeded, the drive-side coupling element (2) and the output-side coupling element (3) can rotate relative to one another.

10. The overload coupling (1) according to claim 9, wherein the power accumulator comprises at least one spring element (6), in the form of a compression spring or in the form of a poppet spring, which is mounted on the center bearing pin (4).

11. The overload coupling (1) according to claim 10, wherein a counter-bearing element (7), which is washer-shaped or plate-shaped, is arranged on an end region of the center bearing pin (4) that faces away from the drive-side coupling element (2), and wherein the at least one spring element (6) is mounted on the center bearing pin (4) in such a way that an end region of the spring element (6) facing away from the drive-side coupling element (2) impacts the washer-shaped or plate-shaped counter-bearing element (7).

12. The overload coupling (1) according to claim 1,
wherein the drive-side coupling element (2) is configured as a washer-shaped or plate-shaped element on a first end region of a drive shaft (8), wherein a second end region of the drive shaft (8) opposite the first end region of the drive shaft (8) is or can be operatively connected to a drive (9), an electromotive drive (9), wherein a lateral face of the washer-shaped or plate-shaped element facing away from the second end region of the drive shaft (8) is equipped with the first front toothing (5.1).

13. The overload coupling (1) according to claim 10, wherein the output-side coupling element (3) has a region (10), a washer-shaped or plate-shaped region, with a passage (11), a center passage, through which the center bearing pin (4) is guided, wherein an end region, facing the drive-side coupling element (2), of the at least one spring element (6) abuts against the region (10), which is washer-shaped or plate-shaped, of the output-side coupling element (3).

14. The overload coupling (1) according to claim 13, wherein a side surface, facing away from the at least one spring element (6), of the region (10), which is washer-shaped or plate-shaped, of the output-side coupling element (3) is provided with the second front toothing (5.2).

15. An actuation mechanism (20) for actuating a charging, fueling, or service flap (21) on a charging, fueling, or service compartment (35) that is or can be received on or in a body component of a vehicle, wherein the charging, fueling, or service flap (21) is reversibly movable, and pivotable, between a closed position and an open position in relation to the charging, fueling, or service compartment (35), wherein the actuation mechanism (20) comprises the following:
a drive (9) in the form of an electromotive; and
a kinematics (22) associated with the drive (9) and configured to tap a rotational movement of the drive (9) when the drive (9) is actuated and convert it into a first movement for moving, and pivoting, the charging, fueling, or service flap (21), wherein the kinematics (22) comprise the overload coupling (1) according to claim 1.

16. The actuation mechanism (20) according to claim 15,
wherein the actuation mechanism (20) further comprises a flap lock (37) for locking the charging, fueling, or service flap (21) in its closed position, wherein the flap lock (37) has a locking position in which the flap lock (37) locks the charging, fueling, or service flap (21) and a release position in which the charging, fueling, or service flap (21) can be moved in relation to the flap lock (37); and
wherein the kinematics (22) associated with the drive (9) is configured to tap a rotational movement of the drive (9) when the drive (9) is actuated and convert it into a first movement for moving, and pivoting, the charging, fueling, or service flap (21) and into a second movement for manipulating the flap lock (37).

17. The actuation mechanism (20) according to claim 16, wherein the kinematics (22) is configured to tap the rotational movement of the drive (9) for the first movement to open the charging, fueling, or service flap (21) only when the flap lock (37) has been transferred into its release position by the second movement.

18. The actuation mechanism (20) according to claim 16, wherein the actuation mechanism (20) further comprises the following:
a first transfer shaft (29) connected to the flap lock (37) in such a way that the flap lock (37) can be pivoted, by a rotational movement, of the first transfer shaft (29) between the locking position and the release position; and
a pushing element (40) connected to the first transfer shaft (29) and configured to push the charging, fueling, or service flap (21) out of its closed position away from the charging, fueling, or service compartment (35) after the flap lock (37) has been transferred into its release position,
wherein the kinematics (22) is configured to transfer the rotational movement of the drive (9) to the first transfer shaft (29) in order to move the flap lock (37) between the locking position and the release position, wherein the actuation mechanism (20) comprises a second transfer shaft (41), which is or can be connected to the charging, fueling, or service flap (21) in such a way that the charging, fueling, or service flap (21) can be pivoted between the closed position and the open position by a rotational movement of the second transfer shaft (41), and wherein the kinematics (22) is configured to transfer the rotational movement of the drive (9) to the second transfer shaft (41).

19. The actuation mechanism (20) according to claim 18, wherein the overload coupling (1) is configured to decouple the drive (9) from the second transfer shaft (41) as soon as a resistance against the first movement exceeds a threshold value, and wherein the kinematics (22) is configured to continue transferring the rotational movement of the drive (9) to the first transfer shaft (29) if the threshold value is exceeded.
